(19) United States
(12) Patent Application Publication
(10) Pub. No.: US 2013/0236327 A1
(43) Pub. Date: Sep. 12, 2013

(54) ADVANCED AERODYNAMIC AND STRUCTURAL BLADE AND WING DESIGN

(71) Applicant: Richard E. Wirz, Altadena, CA (US)

(72) Inventor: Richard E. Wirz, Altadena, CA (US)

(73) Assignee: THE REGENTS OF THE UNIVERSITY OF CALIFORNIA, Oakland, CA (US)

(21) Appl. No.: 13/581,278

(22) PCT Filed: Feb. 25, 2011
(86) PCT No.: PCT/US11/26367

§ 371 Date: Aug. 24, 2012

Related U.S. Application Data
(60) Provisional application No. 61/308,214, filed on Feb. 25, 2010.

(51) Int. Cl. F03D 1/06

(52) U.S. Cl. CPC F03D 1/0675
USPC 416/239

(57) ABSTRACT

An airfoil having an inboard blade section (106) and an outboard blade section (108). The inboard blade section (106) has a mid-blade end (114), and the inboard blade section (106) includes a biplane wing (116). The multiplane wing (116) has a first blade (118) and a second blade (120). The first blade (118) has a first airfoil cross-section (122), and the second blade (120) has a second airfoil cross-section (132). The first blade (118) is generally parallel to the second blade (120). The outboard blade section (108) has a mid-blade end (148), and the outboard blade section (108) includes a monoplane wing (156) with a third airfoil cross-section (158). The mid-blade end (148) of the outboard blade section (108) is joined to the mid-blade end (114) of the inboard blade section (106).

### CROSS-REFERENCES TO RELATED APPLICATIONS

This patent application claims the benefit of U.S. Provisional Patent Application Ser. No. 61/308,214 filed Feb. 25, 2010 for Advanced Aerodynamic and Structural Blade and Wing Design. That application is incorporated here by this reference.

### TECHNICAL FIELD

This invention relates to blade designs for fluid turbine blades, wings, pumps, and propellers.

### BACKGROUND ART

Wind turbine blades currently use airfoil cross-sections that are very thick near the root (near the rotor hub) to accommodate the large loads on this region of the blade. Since these thick airfoils exhibit relatively poor aerodynamic performance, current wind turbine blade performance and length is limited by the competing needs to reduce airfoil thickness for performance and increase the blade root thickness to accommodate structural and dynamic loads.

Early planes often used two or more wings to increase lifting surface area, but modern single wing designs have replaced multi-wing configurations. However, non-planar and multiplanar designs are still considered by some investigators.

Recent efforts in the field of aerodynamic flow control for wind turbines have focused on increasing the aerodynamic efficiency, or Lift-to-Drag ratio (L/D), by means of controlling boundary layer separation. This has been achieved to a certain extent by means of synthetic jets, trailing edge flaps and wedges, stall strips, and vortex generators, though none of these approaches has sufficiently addressed the structural loading challenge for turbine blade growth.

Wind turbine blades are separated into two main sections: inboard and outboard. The inboard section supports most of the structural load and supplies the torque necessary for the rotor to start turning at the lower end of the wind range. For this, it is required to have a thick (˜30% of chord) airfoil cross section, and high enough lifting capability (Cₗ˜1.5) despite its thickness. (Refer to FIG. 1.) The outboard section supplies the lift necessary to keep the rotor turning once it has started to rotate, and it consists of highly cambered airfoil sections with different characteristics for pitch or stall controlled turbines. Generally, the L/D of the outboard section is greater than that of the inboard section. For most of the flow control approaches mentioned above, the increase in lift for the inboard sections is accompanied by increased drag, which decreases the aerodynamic efficiency.

The manufacturing of larger wind turbines has been hindered previously by the structural limitations that arise when equipping turbines with longer blades, and hence higher loads requiring more rigid inboard supporting structures, to the point where the inboard section of larger blades ceases its aerodynamic purpose in exchange for a sound structural support for the rest of the blade. Current blades have already proven to be most inefficient at the inboard section due to their near circular cross section.

Traditionally, the inboard sections provide sufficient lift to start the rotor, while the outboard sections produce positive torque at higher rotor rotation rates. Current designs of very large turbines require inboard sections that are sufficiently stout to handle the loads due to the long and heavy blades. As a result, these stout inboard sections cannot start the rotors and require energy input to start the rotor and are an aerodynamic liability during nominal operation.

Consequently, one goal of the disclosed design is to improve aerodynamics of wind turbine blades and airplane wings while maintaining or improving structural characteristics.

### DISCLOSURE OF INVENTION

The disclosed device focuses on increasing the aerodynamic efficiency of the inboard section while improving the structural load capability of the blade by using a biplanar airfoil section. In their application to the wind turbine blade inboard section, biplanar sections are beneficial in the following ways:
a. At the inboard section of the rotor the distributed load is best supported by the high moment of inertia of the efficient wide-flange beam structure (e.g., an I-beam or structural channel). A multi-planar section provides this structure while allowing the air to pass between the planes.
b. The biplanar inboard section is bounded by the rotor hub and the outboard blade section, thus creating a box wing that is extremely efficient due to the suppression of wingtip vortices.

As the strength of the inboard section is increased, the length of the blade can be increased, too, consequently decreasing the life-cycle cost of energy.

A biplane inboard section as disclosed here will improve the inboard section's lifting capability dramatically, will reduce or eliminate starting energy, and will improve overall efficiency at higher rotation rates. Consequently, the biplane design has several positive effects, including:
i. Reduced life-cycle cost of energy (COE) for conventional high power (> 0.5 MWe) turbines;
ii. Structural strength sufficient for growth to the next generation of large (> 3 MWe) turbines;
iii. Improved aerodynamic performance that will reduce or eliminate rotor starting energy for large turbines; and
iv. Improved strength sufficient for demanding off-shore wind turbine applications.

This concept employs a multi-plane configuration for a single wind turbine blade. The concept may use multiple planes along the entire length; however, initial calculations suggest that maximum overall performance of a single blade is obtained by using two planes near the root to provide structural strength while the outboard portion of the blade is a single plane. Possible configurations for a bi-planar inboard section with a single plane outboard section are shown in FIG. 2 and FIG. 3.

This design provides significant advantages over the state-of-the-art thick blade roots since the flow is allowed to pass between the planes, thus increasing overall lift and decreasing drag relative to single-plane inboard designs. This design is structurally effective since the compressive and tensile stresses on the wing predominantly act away from the center of the member. Therefore, this design partially emulates the structural advantages of the bi-planar flange design of an I-beam or structural channel. From an aerodynamic standpoint, the inboard planes must be spaced sufficiently apart to reduce the aerodynamic interference, which is a measure of the induced drag due to the multi-plane configuration. FIG. 3 shows that the inboard planes can be staggered to improve performance for higher angles of attack (which accounts for higher blade rotation speeds for the wind turbine application).

This same concept may be used for an airplane such that multiple blades (likely two) are used near the fuselage while the outboard portion is a single blade as in conventional designs. Likewise, the concept may be used for any fluid turbine, pump, or propeller. Consequently, the airfoil may be thought of as a “fluid-foil” in applications involving a fluid other than air.

Currently, the size of wind turbines is limited by the square-cubed law. It states that while the power generated by a turbine increases with respect to its diameter squared, the material cost for manufacture increases as the diameter cubed. While current blades have shown that the material cost can be reduced to near the 2.3 power, there is a limit beyond which the increased productivity of large turbine blades will not outweigh the increased manufacturing cost.

By using a multi-planar inboard section the structural rigidity can be greatly increased. A more efficient inboard section allows a reduction in the amount of material for the blade, thus decreasing its overall weight and the structural requirements for the tower. The advantages of the multi-planar inboard section also include the viability of larger blades and enhanced power generation for blades of equal size. This can result in a material cost less than is currently achievable (diameter raised to the 2.3 power) and power generation superior to the diameter squared, surpassing the limiting barrier between power generation and manufacturing cost.

Accordingly, in one aspect the invention is a rotor blade for a wind turbine in relation to a wind direction that has a blade root, an inboard blade section, and an outboard blade section. The inboard blade section has a length, an inboard end, and a mid-blade end opposite the inboard end. The inboard end of the inboard blade section is joined to the blade root. The inboard blade section is a biplane wing that includes a first blade and a second blade. The first blade has a first airfoil cross-section, a first leading edge, a first trailing edge, a first chord, and an upper surface. The second blade has a second airfoil cross-section, a second leading edge, a second trailing edge, a second chord, and a lower surface. The second blade is downwind from the first blade with respect to the wind direction. The outboard blade section has a length, a mid-blade end, an outboard end opposite the mid-blade end, an upper surface, and a lower surface. The outboard blade section is a monoplane wing with a third airfoil cross-section, a third leading edge, a third trailing edge, and a third chord. The mid-blade end of the outboard blade section is joined to the mid-blade end of the inboard blade section.

In another aspect, the invention is a wind turbine blade array having a hub and a plurality of turbine blades radiating from the hub. Each turbine blade in the plurality of turbine blades includes an inboard blade section and an outboard blade section. The inboard blade section has a length, an inboard end, and a mid-blade end opposite the inboard end. The inboard end of the inboard blade section is joined to the blade root. The inboard blade section is a biplane wing with a first blade and a second blade. The first blade has a first airfoil cross-section, a first leading edge, a first trailing edge, a first chord, and an upper surface. The second blade has a second airfoil cross-section, a second leading edge, a second trailing edge, a second chord, and a lower surface. The second blade is downwind from the first blade with respect to the wind direction. The outboard blade section has a length, a mid-blade end, an outboard end opposite the mid-blade end, an upper surface, and a lower surface. The outboard blade section is a monoplane wing with a third airfoil cross-section, a third leading edge, a third trailing edge, and a third chord. The mid-blade end of the outboard blade section is joined to the mid-blade end of the inboard blade section.

In yet another aspect, the invention is an airfoil that has an inboard blade section and an outboard blade section. The inboard blade section has a mid-blade end, and the inboard blade section includes a biplane wing. The biplane wing has a first blade and a second blade. The first blade has a first airfoil cross-section, and the second blade has a second airfoil cross-section. The first blade is generally parallel to the second blade. The outboard blade section has a mid-blade end, and the outboard blade section includes a monoplane wing with a third airfoil cross-section. The mid-blade end of the outboard blade section is joined to the mid-blade end of the inboard blade section.

In still another aspect, the invention is a wing for an airplane having a wing root, an inboard wing section, and an outboard wing section. The inboard wing section has a length, an inboard end, a mid-wing end opposite the inboard end, and a direction of lift. The inboard end of the inboard wing section is joined to the wing root. The inboard wing section is a biplane wing with a first wing and a second wing. The first wing has a first airfoil cross-section, a first leading edge, a first trailing edge, a first chord, and an upper surface. The second wing has a second airfoil cross-section, a second leading edge, a second trailing edge, a second chord, and a lower surface. The second wing is below the first wing with respect to the direction of lift. The outboard wing section has a length, a mid-wing end, an outboard end opposite the mid-wing end, an upper surface, and a lower surface. The outboard wing section is a monoplane wing with a third airfoil cross-section, a third leading edge, a third trailing edge, and a third chord. The mid-wing end of the outboard wing section is joined to the mid-wing end of the inboard wing section.

### BRIEF DESCRIPTION OF DRAWINGS

FIG. 1 is an illustration of contemporarily employed stout inboard airfoil sections.

FIG. 2 is a front view of wind turbine blade with bi-planar inboard section. This figure is for schematic reference, and the inboard section might also have a rotated profile (as shown for the outboard section in this figure). Also, if this concept is used for a wing the outboard section preferably would not be rotated.

FIG. 3 is a front view of the inboard bi-planar section with single plane outboard section (view from root). The inboard section is offset to improve aerodynamic performance.

FIG. 4 shows local aerodynamic loads on a wind turbine airfoil section.

FIG. 5 is a depiction of governing parameters for moment of inertia.

FIG. 6 is a schematic of the biplane concept fit to a wide-flanged beam, and to its right, a stress loading diagram resulting from moments about the z-axis.

FIG. 7 is an illustration of an embodiment of the disclosed concept with a comparison table relating to structural and aerodynamic forces.

FIG. 8 is a comparison of viscous and pressure contributions to aerodynamic performance for FFA 30.1% thick and SC₂-0714 biplane.

FIG. 9 is an L/D comparison for 30.1% thick FFA airfoil and SC₂-0714 biplane.

FIG. 10 is similar to FIG. 2 but includes the reference numbers for the labeled components.

FIG. 11 is portion of FIG. 7 reproduced to show the reference numbers for the inboard section. The figure is a cross-section through the biplane blade.

FIG. 12 is portion of FIG. 7 reproduced to show the reference numbers for the outboard section. The figure is a cross-section through the monoplane blade.

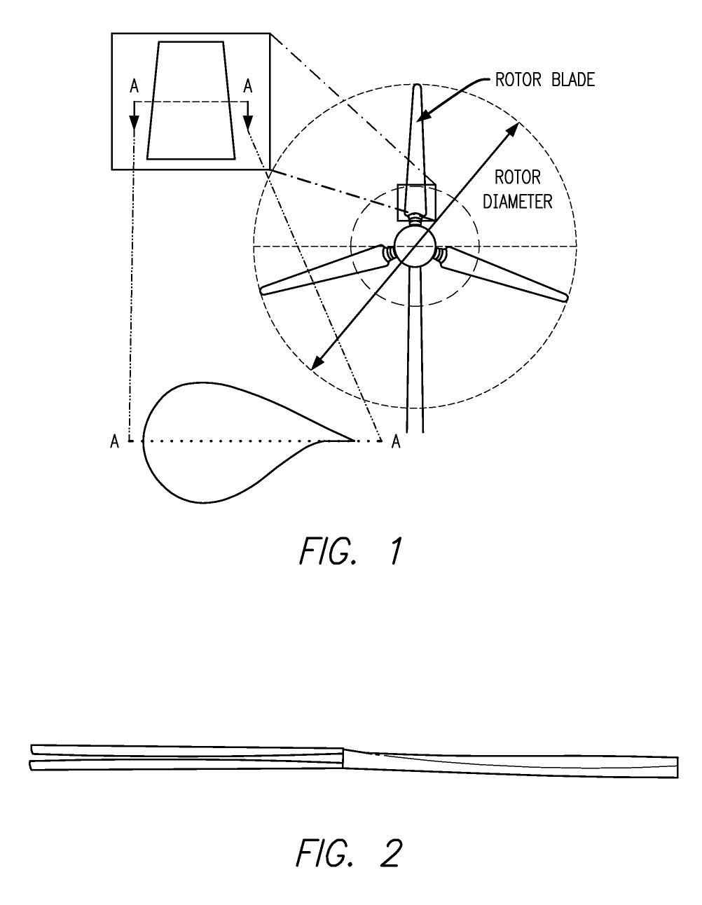

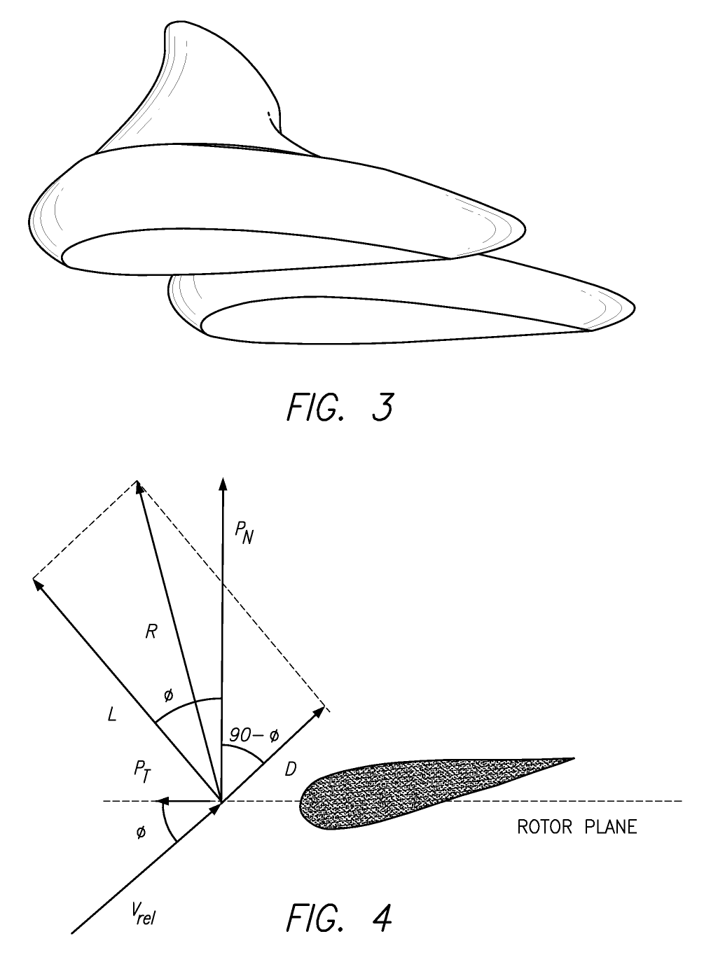

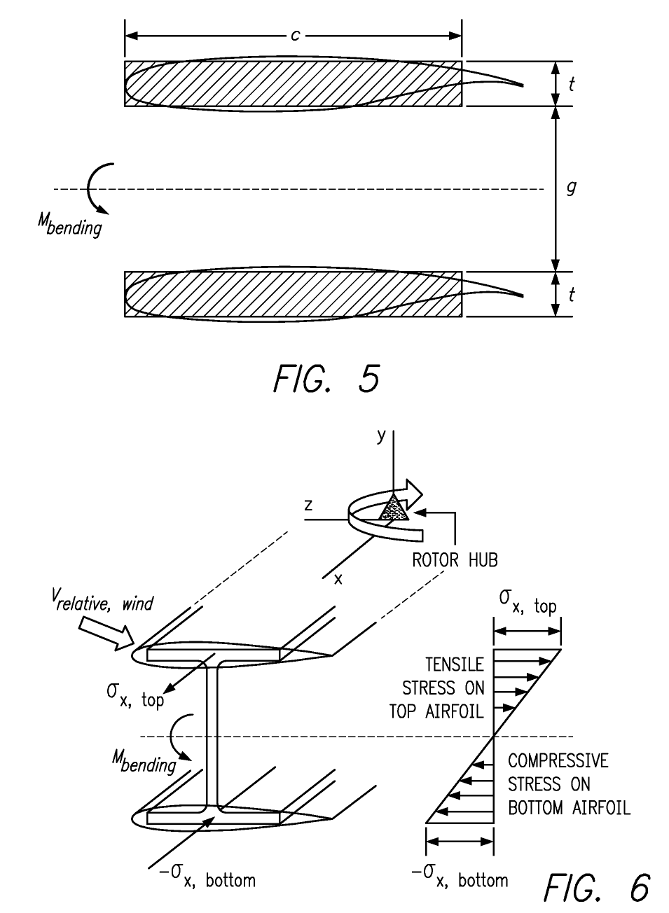

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present disclosure provides an improved wind turbine and airplane wing design while maintaining or improving blade structural characteristics by incorporating a biplane inboard section.

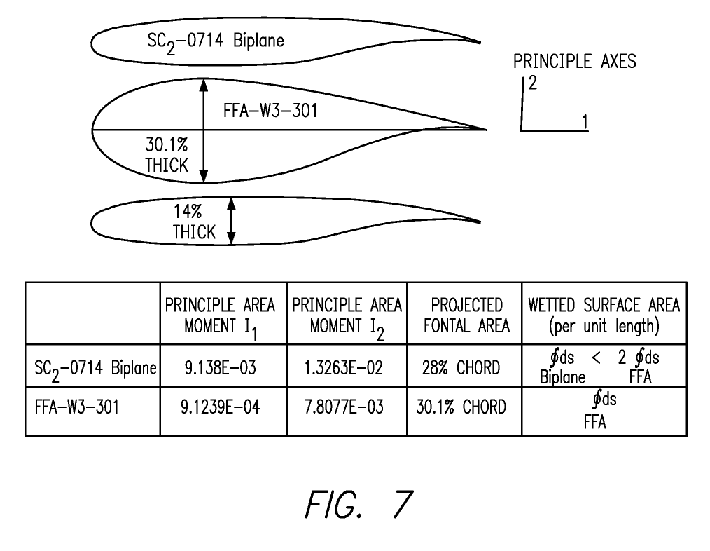

Results from analysis of this concept are provided below using a biplane composed of SC₂-0714 airfoils as the alternative to the thick inboard airfoil from a state-of-the-art blade. The SC₂-0714 airfoil profile is shown in FIG. 7. The stacked supercritical airfoil profiles resemble a sandwich beam, which is the basic principle for the proposed design, so the chord lengths of the thick and biplanar airfoils were matched in the interest of the structural integrity of the preliminary design. Furthermore, preliminary calculations show the allowable bending moment for the supercritical biplane is ten times that of the thick monoplane.

From an aerodynamic standpoint, the increased rotor diameter increases power production rates by more than just the diameter squared, since it improves access to greater wind resources at higher altitudes and the overall lift-to-drag ratio would be increased for the multi-planar inboard section. So, although the cost of development for the disclosed concept might initially be high, the life-cycle cost of energy and overall system costs are reduced and the possibility of making larger blades becomes more reasonable. This aspect is attractive for the growth of the struggling offshore wind energy sector, and for the future growth of turbines to meet DOE wind turbine growth targets.

One issue targeted by the disclosed concept directly relates to the increased demand for renewable energy over fossil energy sources. The land-area available for wind power generation on our planet is limited, and there are inherent interferences and efficiency detriments that limit decreasing the separation between turbines. The optimal solution is to enhance the energy production of each turbine by increasing its size, instead of solely increasing the number of wind turbines. This improvement would also contribute to making use of better wind resources at higher altitudes. Overall, the disclosed concept impacts wind turbine efficiencies by allowing larger rotor diameters and contributes to the viability of offshore wind power generation by improving blade strength for all sizes. Additionally, improved aerodynamics of the inboard region improves the wake and thus allows for tighter spacing of the wind turbines, and hence, improved land usage.

All contemporary large wind turbines make use of a mono-planar airfoil section throughout the entire blade. By using a biplane for the inboard section, the effective wing area is increased for a given span. Roughly speaking, the lifting capability of a wing is directly related to the wing area, the biplane inboard section will perform better than the equivalent monoplane for the given span based on the following relationship for the lift L of a wing:

L=½ρ_{∞}V_{∞}²C_{L}S

Where S is the wing area, C_{L} is the lift coefficient, and ρ_{∞} and V_{∞} are the free stream air density and velocity, respectively.

Considering the blade cross-section will locally be at a certain angle Φ (local flow angle) with respect to the relative velocity of the incoming flow, the resultant (R) between the lift (L) and drag (D) forces generated will translate into a force component p_{T}, tangential to the rotor plane, and a force component p_{N}, normal to the rotor plane. These become the forces responsible for turning the rotor and structurally loading the blade, respectively.

FIG. 4 shows how certain 2-D aerodynamic studies predict the lift and drag forces on the inboard section of the blade. These forces can then be applied to computational models, such as the Blade Element Momentum (BEM) model, which approximates wind turbine performance by analyzing the discrete annular control volumes that comprise the rotor, to obtain data for the 3-D wind turbine performance. The BEM model accounts for tip loss factors via Prandtl's and Glauert's corrections to the basic momentum theory. 2-D CFD (computational fluid dynamics) analysis provides lift and drag forces for the airfoil section under consideration. These forces can be normalized to yield lift and drag coefficients, Cₗ and C_{d}. Then, the contribution of each annular element to the torque about the rotor's axis and the bending force normal to the rotor plane is determined by the normal and tangential force coefficients, which happen to be the normalized version of p_{T} and p_{N}. These force coefficients use the airfoil section data obtained from CFD in the following way.

Cₜ=Cₗ sin Φ−C_{d} cos Φ

Cₙ=Cₗ cos Φ−C_{d} sin Φ

According to Prandtl et al., the efficiency of a biplane configuration depends on the gap and stagger between the two airfoils, the twist, and the wingspan. It was also noted that the most efficient biplane would have the same span and wing area for both top and bottom planes, as well as endplates to suppress the wingtip effects. For the basic biplane bounded by endplates (or box-wing), the ratio of its induced resistance to the resistance of a monoplane of the same span providing the same total lift, is:

$$v = \frac{{C}_{{D}_{{i}_{biplane}}}}{{C}_{{D}_{{i}_{monoplane}}}} = \frac{1 + 0.45 \frac{g}{b}}{1.045 + 2.8 \frac{g}{b}}$$

Here, g is the gap between wings and b is the span of the plane in question. The relationship above shows the biplane's aerodynamic performance improves as the gap increases. Conversely, a gap that is too small results in inefficient aerodynamic performance.

So, although the predicted box wing configuration will suppress the main component of the induced drag (i.e. wingtip vortices), the interference factor will not allow us to omit this term completely.

Another way in which the disclosed concept improves upon existing blade design is the structural rigidity introduced by the multi-planar concept. Since the interference between the two planes is diminished when they are separated by an infinite distance, a larger gap would improve both the aerodynamic performance and structural rigidity, allowing for larger and more efficient blades. In practice, the most commonly used gap is equal to one chord length of the airfoil section. This design would resemble that of a wide-flanged beam (or I-beam). The I-beam is extensively used in demanding structural applications due to its increased moment of inertia when compared to its rectangular or circular cross section counterparts. The moment M_{z} to which a beam can be subjected is a function of the material's yielding stress, the moment of inertia, and the distance from the centroid of the geometry where the load is applied.

$${M}_{z} = \frac{{σ}_{y} I}{y}$$

Where σ_{y} is the yield stress of the material, I is the moment of inertia, and y is the distance to the centroid. From this it is clear that a higher moment of inertia allows for higher bending moments, and in turn higher loads.

The moment of inertia is a parameter determined by the cross-sectional geometry of a beam which is subjected to loads in a certain plane. In the multi-planar inboard section case, the moment of inertia is determined mainly by the chord length c, the distance g between the two airfoils, and their thickness, t. Like for a sandwich beam, it can be approximated with the following equation.

$$I = \frac{c}{12} \{ {( g + 2 t )}^{3} - {( g )}^{3} \}$$

Hence, a larger gap would increase the moment of inertia of our cross section, resulting in a higher moment carrying capability. This relationship shows that the wide-flanged beam cross-section is structurally more efficient than the rectangular or circular cross-sections.

FIG. 6 shows how a biplane configuration can be fit to replace the thick inboard section of current blades. Note that in lieu of a neutral axis (or web) the multi-planar structure is supported on either end. Since the moment loading (compressive and tensile stress) is carried by the flanges, introducing the gap between the blades is a feasible modification since they will act as the flanges of an I-beam, thus sustaining the application of larger loads to the entire blade due to the increased moment of inertia. The gap will also contribute to the aerodynamic qualities of this section.

An analysis of the disclosed concept was performed by replacing the thick inboard blade section (30.1% thick FFA airfoil) for a 20.5 m blade with a biplanar design of identical chord length, as shown in FIG. 6. FFA refers to the Aeronautical Research Institute of Sweden, and the 30.1% thick FFA airfoil profile is shown in FIG. 7. The beneficial result of this analysis is more pronounced for the much more circular inboard airfoils used for larger turbine designs.

The principle area moments (or “2-D moments of inertia”) are the structural parameters that determine the first-order load bearing capability of the blade. FIG. 7 shows that the biplane section provides an order of magnitude improvement to principle area moment, thus allowing much longer and stronger blades for the same blade root chord length.

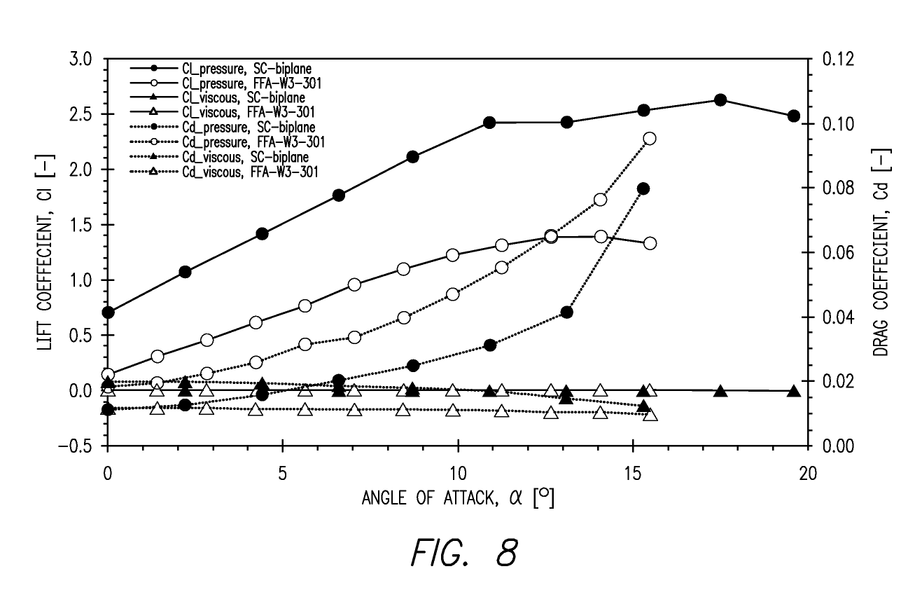

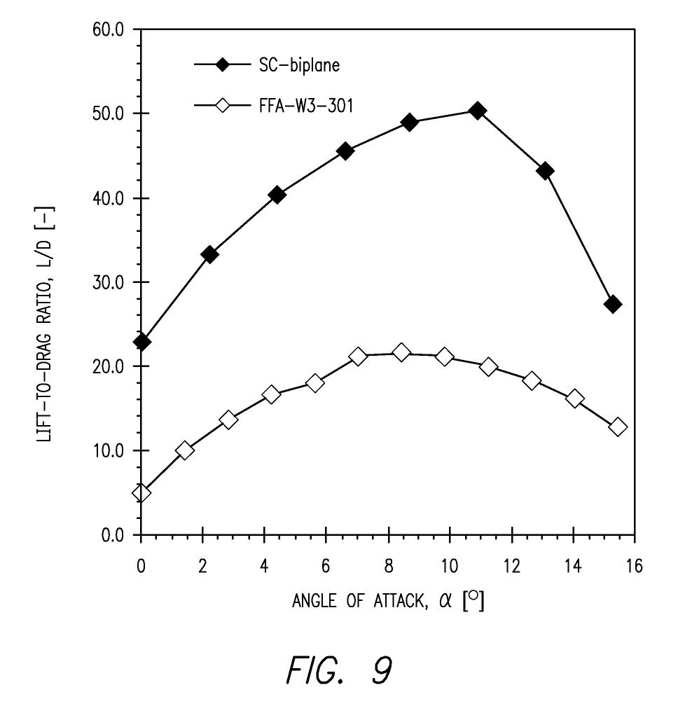

Regarding aerodynamic performance, plots of results from CFD analysis of both cross-sections (FIGS. 8 and 9) show that the biplanar design provides a dramatic improvements in overall lift and drag. These improvements are due to the pressure components of the lift and drag while viscous affects have a relatively minimal effect on the comparative performance.

Overall, these analyses demonstrate that a biplane inboard section of dimensions comparable to the 30.1% thick inboard section will result in an increased Lift-to-Drag ratio as well as improved rigidity, thus allowing more efficient and larger wind turbine blades. From the relationships identified above, this novel design translates into:
(a) higher section lift;
(b) lower section drag;
(c) increased allowable torque at the inboard section;
(d) higher overall blade efficiency;
(e) lower cost of operation, and manufacturing; and
(f) low starting (cut-in) and higher top (cut-out) speed for the rotor, thus improving overall energy that can be extracted from the wind.

The average cost of wind energy to the consumer is about 10 ¢/kWh. Our estimates show that solely by aerodynamic improvements on the inboard section of the blade, a 10% increase in efficiency can be achieved in the nominal range of operation. In expanding the wind range and starting the turbine at lower speeds (˜4 m/s), we have calculated about an extra 2% increase in efficiency. Therefore, the cost per kWh for the consumer would be reduced by 12% to around 8.78 ¢/kWh.

In terms of the square-cubed law (used to associate the rotor diameter with increases in power generation and material costs) the material cost curve is affected by the structurally more efficient multi-planar inboard section. Current technologies have lowered the material cost to the diameter raised to the 2.3 power. With the structurally more efficient biplane section, material costs could be reduced even further, to the point where the threshold for turbine rotor diameter growth is no longer hindered by material costs overcoming power generation outputs.

Finally, the increased rotor diameter allows for a more reliable offshore energy production market as well as reductions in pollutant emissions linked to electric power generation, thus contributing to the quality of life of the general electric consumer.

Based on the U.S. Department of Energy's (DOE) report, “20% Wind Energy by 2030”, innovations like the one disclosed here would qualitatively avoid air pollution and greenhouse gas emissions associated with the electric sector. It also contributes to U.S.A.'s energy independence and the stabilization of prices for consumers by reducing the demand of fossil fuels with a more reliable natural resource, such as wind. The United States would also benefit from extra income in rural areas and offshore installations, as well as the collection of tax revenues from the development of wind energy production areas. The job market would also be affected positively as the sector grows, and the life-cycle cost of energy will be reduced as the size of the wind turbines is increased. Overall, the growth of the wind energy industry by means of increasing rotor sizes would result in a cheaper and more efficient energy system.

From the calculations carried out above, we have estimated a 1.22 ¢/kWh reduction cost. In 2004, the US annual per capita energy consumption was 13,351 kWh. Using the US Census Bureau population estimate of 308,745,538 inhabitants for the U.S., and considering the US DOE's goal of “20% Wind Power by 2030”, the total savings calculated for consumers in the U.S. due to the disclosed innovation would be of $10B annually.

As such, this invention is very attractive to a wide variety of energy companies, especially with the current enthusiasm for energy technologies in the national and international marketplace. This technology is particularly attractive for new large turbine installations and future larger-scale installations that would be enabled by this concept. Also, many older turbine installations are retrofitted with new blades to take advantage of the improved performance of newer blade designs. Therefore this invention is attractive to both new and old wind turbine installations may also be used for smaller scale, just more beneficial at large scale.

Accordingly and with reference to the figures, in one aspect the invention is a rotor blade 100 for a wind turbine in relation to a wind direction 102 that has a blade root 104, an inboard blade section 106, and an outboard blade section 108.

The inboard blade section 106 has a length 110, an inboard end 112, and a mid-blade end 114 opposite the inboard end 112. The inboard end 112 of the inboard blade section 106 is joined to the blade root 104. The inboard blade section 106 is a biplane wing 116 that includes a first blade 118 and a second blade 120. The first blade 118 has a first airfoil cross-section 122, a first leading edge 124, a first trailing edge 126, a first chord 128, and an upper surface 130. The second blade 120 has a second airfoil cross-section 132, a second leading edge 134, a second trailing edge 136, a second chord 138, and a lower surface 140. The second blade 120 is downwind from the first blade 118 with respect to the wind direction 102. In keeping with the usual convention, the wind direction 102 shown in the figures points into the wind. In a version of the invention, the first chord 128 is generally parallel to the second chord 138. The first airfoil cross-section 122 and the second airfoil cross-section 132 are each of a more slender airfoil cross-section than a traditional inboard foil, such as the a SC₂-0714 airfoil profile used in the previous example. However, the airfoil cross-sections for the multiplanar design may be tapered from the root to the interface to optimize aerostructural performance.

The outboard blade section 108 has a length 146, a mid-blade end 148, an outboard end 150 opposite the mid-blade end 148, an upper surface 152, and a lower surface 154. The outboard blade section 108 is a monoplane wing 156 with a third airfoil cross-section 158, a third leading edge 160, a third trailing edge 162, and a third chord 164. The outboard cross-section 158 may be appropriately tapered to optimize aerostructural performance. The mid-blade end 148 of the outboard blade section 108 is joined to the mid-blade end 114 of the inboard blade section 106. Preferably, the upper surface 130 of the first blade 118 joins smoothly with the upper surface 152 of the outboard blade section 108 and the lower surface 140 of the second blade 120 joins smoothly with the lower surface 154 of the outboard blade section 108. In some embodiments, the first chord 128, the second chord 138, and the third chord 164 are each equal at the mid-blade end 114, 148 of the respective inboard blade section 106 and outboard blade section 108. The interface region is located to optimize aerostructural performance.

In a version of the invention, the first blade 118 has a positive stagger with respect to the second blade 120 such that the first leading edge 124 is offset from the second leading edge 134 into a direction of thrust 142 and the first trailing edge 126 is offset from the second trailing edge 136 into the direction of thrust 142. In a version of the invention, the first blade 118 has a negative stagger with respect to the second blade 120 such that the second leading edge 134 is offset from the first leading edge 124 into a direction of thrust 142 and the second trailing edge 136 is offset from the first trailing edge 126 into the direction of thrust 142. Similarly, inboard section may use different airfoil sections and different angles of attack to optimize aerostructural performance.

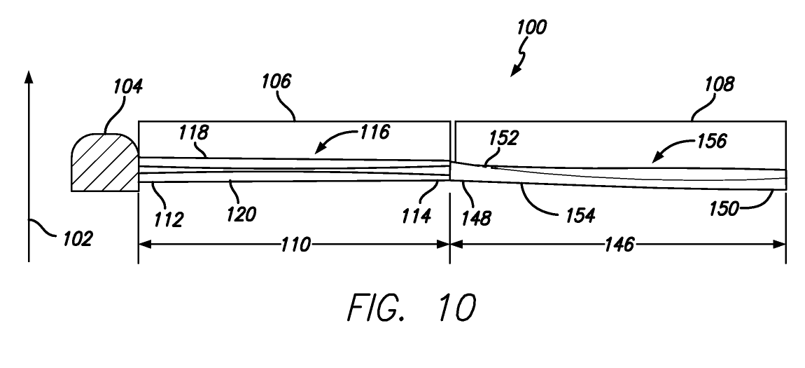

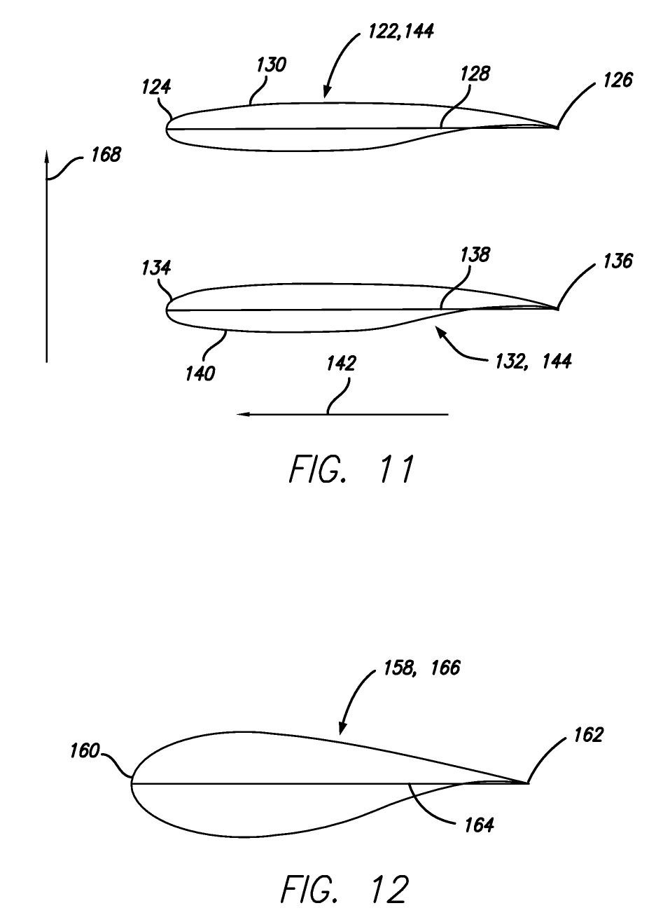

Preferably, the length 110 of the inboard blade section 106 is one-quarter the length 146 of the outboard blade section 108. Another way of stating this is that the inboard blade section 106 is twenty percent of the combined lengths of the inboard blade section 106 and the outboard blade section 108. Referring to FIG. 10, length 110 can be any length relative to 146, depending on the specific application. Initial calculations show that optimally, the inboard is about 20% of the outboard section for most applications.

In another aspect, the invention is a wind turbine blade array having a hub and a plurality of turbine blades radiating from the hub. Each turbine blade in the plurality of turbine blades includes an inboard blade section 106 and an outboard blade section 108.

The inboard blade section 106 has a length 110, an inboard end 112, and a mid-blade end 114 opposite the inboard end 112. The inboard end 112 of the inboard blade section 106 is joined to the blade root 104. The inboard blade section 106 is a biplane wing 116 with a first blade 118 and a second blade 120. The first blade 118 has a first airfoil cross-section 122, a first leading edge 124, a first trailing edge 126, a first chord 128, and an upper surface 130. The second blade 120 has a second airfoil cross-section 132, a second leading edge 134, a second trailing edge 136, a second chord 138, and a lower surface 140. The second blade 120 is downwind from the first blade 118 with respect to the wind direction 102. In a version of the invention, the first blade 118 is staggered with respect to the second blade 120. The first airfoil cross-section 122 and the second airfoil cross-section 132 may be each a SC₂-0714 airfoil profile 144.

The outboard blade section 108 has a length 146, a mid-blade end 148, an outboard end 150 opposite the mid-blade end 148, an upper surface 152, and a lower surface 154. The outboard blade section 108 is a monoplane wing 156 with a third airfoil cross-section 158, a third leading edge 160, a third trailing edge 162, and a third chord 164. The 30.1% section is the example of the fat sections used for the inboard of traditional wind turbine blades. It is not appropriate for the outboard section. The outboard section will be aerostructurally optimized as with traditional outboard sections. The mid-blade end 148 of the outboard blade section 108 is joined to the mid-blade end 114 of the inboard blade section 106. Preferably, the upper surface 130 of the first blade 118 blends smoothly with the upper surface 152 of the outboard blade section 108 and the lower surface 140 of the second blade 120 blends smoothly with the lower surface 154 of the outboard blade section 108.

In a version of the invention, the length 110 of the inboard blade section 106 is one-quarter the length 146 of the outboard blade section 108. Preferably, the plurality of turbine blades is three turbine blades radially spaced 120 degrees apart.

In yet another aspect, the invention is an airfoil that has an inboard blade section 106 and an outboard blade section 108. The inboard blade section 106 has a mid-blade end 114, and the inboard blade section 106 includes a biplane wing 116. The biplane wing 116 has a first blade 118 and a second blade 120. The first blade 118 has a first airfoil cross-section 122, and the second blade 120 has a second airfoil cross-section 132. The first blade 118 is generally parallel to the second blade 120. The outboard blade section 108 has a mid-blade end 148, and the outboard blade section 108 includes a monoplane wing 156 with a third airfoil cross-section 158. The mid-blade end 148 of the outboard blade section 108 is joined to the mid-blade end 114 of the inboard blade section 106.

In still another aspect, the invention is a wing for an airplane having a wing root, an inboard wing section, and an outboard wing section.

The inboard wing section 106 has a length 110, an inboard end 112, a mid-wing end 114 opposite the inboard end 112, and a direction of lift 168. The inboard end 112 of the inboard wing section 106 is joined to the wing root 104. The inboard wing section 106 is a biplane wing 116 with a first wing 118 and a second wing 120. The first wing 118 has a first airfoil cross-section 122, a first leading edge 124, a first trailing edge 126, a first chord 128, and an upper surface 130. The second wing 120 has a second airfoil cross-section 132, a second leading edge 134, a second trailing edge 136, a second chord 138, and a lower surface 140. Preferably, the first chord 128 is parallel to the second chord 138. The second wing 120 is below the first wing 118 with respect to the direction of lift 168. In a version of the invention, one or each of the first airfoil cross-section 122 and the second airfoil cross-section 132 is a SC₂-0714 airfoil profile 144.

The outboard wing section 108 has a length 146, a mid-wing end 148, an outboard end 150 opposite the mid-wing end 148, an upper surface 152, and a lower surface 154. The outboard wing section 108 is a monoplane wing 156 with a third airfoil cross-section 158, a third leading edge 160, a third trailing edge 162, and a third chord 164. In a version of the invention, the third airfoil cross-section 158 is a 30.1% thick FFA airfoil profile 166. The mid-wing end 148 of the outboard wing section 108 is joined to the mid-wing end 114 of the inboard wing section 106. Preferably, the upper surface 130 of the first wing 118 joins smoothly with the upper surface 152 of the outboard wing section 108 and the lower surface 140 of the second wing 120 joins smoothly with the lower surface 154 of the outboard wing section 108. In a version of the invention, the first chord 128, the second chord 138, and the third chord 164 are each equal at the mid-wing end 114, 148 of the respective inboard wing section 106 and outboard wing section 108. Preferably, the length 110 of the inboard wing section 106 is one-quarter the length 146 of the outboard wing section 108.

In an embodiment, the first wing 118 has a positive stagger with respect to the second wing 120 such that the first leading edge 124 is offset from the second leading edge 134 into a direction of thrust 142 and the first trailing edge 126 is offset from the second trailing edge 136 into the direction of thrust 142. In another embodiment, the first wing 118 has a negative stagger with respect to the second wing 120 such that the second leading edge 134 is offset from the first leading edge 124 into a direction of thrust 142 and the second trailing edge 136 is offset from the first trailing edge 126 into the direction of thrust 142.

As can be seen, in the context of an airplane wing, “blade,” “blade root,” and “blade section” correspond to the related structures “wing,” “wing root,” and “wing section” discussed for a rotor blade. Likewise, “hub” in the context of a wind turbine blade array corresponds to the related structure “blade root” discussed for a rotor blade.

While the present invention has been described with regards to particular embodiments, it is recognized that additional variations of the present invention may be devised without departing from the inventive concept. For example, the concept may be extended for use in other applications using a fluid turbine, pump, or propeller having a blade or wing.

### INDUSTRIAL APPLICABILITY

This invention may be industrially applied to the development, manufacture, and use of fluid turbine blades, airplane wings, pumps, and propellers.

1. A rotor blade for a wind turbine m relation to a wind direction, the rotor blade comprising:
(a) a blade root;
(b) an inboard blade section having a length, an inboard end, and a mid-blade end opposite the inboard end, the inboard end of the inboard blade section being joined to the blade root, the inboard blade section comprising a biplane wing, the biplane wing having a first blade and a second blade, the first blade having a first airfoil cross-section, a first leading edge, a first trailing edge, a first chord, and an upper surface, the second blade having a second airfoil cross-section, a second leading edge, a second trailing edge, a second chord, and a lower surface, the first chord being generally parallel to the second chord, the second blade being downwind from the first blade with respect to the wind direction, the first blade having a positive stagger with respect to the second blade such that the first leading edge is offset from the second leading edge in a direction of thrust and the first trailing edge is offset from the second trailing edge in a direction of thrust, the first airfoil cross-section and the second airfoil cross-section each being a SC2-0714 airfoil profile; and
(c) an outboard blade section having a length, a mid-blade end, an outboard end opposite the mid-blade end, an upper surface, and a lower surface, the outboard blade section comprising a monoplane wing having a third airfoil cross-section, a third leading edge, a third trailing edge, and a third chord, the third airfoil cross-section being a 30.1% thick FF A airfoil profile;
wherein the mid-blade end of the outboard blade section is joined to the mid-blade end of the inboard blade section such that the upper surface of the first blade joins smoothly with the upper surface of the outboard blade section and the lower surface of the second blade joins smoothly with the lower surface of the outboard blade section;
wherein the first chord, the second chord, and the third chord are each equal at the mid-blade end of the respective inboard blade section and outboard blade section; and
wherein the length of the inboard blade section is one-quarter the length of the outboard blade section.

2. A rotor blade for a wind turbine m relation to a wind direction, the rotor blade comprising:
(a) a blade root;
(b) an inboard blade section having a length, an inboard end, and a mid-blade end opposite the inboard end, the inboard end of the inboard blade section being joined to the blade root, the inboard blade section comprising a biplane wing, the biplane wing having a first blade and a second blade, the first blade having a first airfoil cross-section, a first leading edge, a first trailing edge, a first chord, and an upper surface, the second blade having a second airfoil cross-section, a second leading edge, a second trailing edge, a second chord, and a lower surface, the second blade being downwind from the first blade with respect to the wind direction; and
(c) an outboard blade section having a length, a mid-blade end, an outboard end opposite the mid-blade end, an upper surface, and a lower surface, the outboard blade section comprising a monoplane wing having a third airfoil cross-section, a third leading edge, a third trailing edge, and a third chord, the mid-blade end of the outboard blade section being joined to the mid-blade end of the inboard blade section.

3. The rotor blade of claim 2, where the first chord is generally parallel to the second chord.

4. The rotor blade of claim 2, the first blade having a positive stagger with respect to the second blade such that the first leading edge is offset from the second leading edge into a direction of thrust and the first trailing edge is offset from the second trailing edge into the direction of thrust.

5. The rotor blade of claim 2, the first blade having a negative stagger with respect to the second blade such that the second leading edge is offset from the first leading edge into a direction of thrust and the second trailing edge is offset from, the first trailing edge into the direction of thrust.

6. The rotor blade of claim 2, where the first airfoil cross-section is a SC2-0714 airfoil profile.

7. The rotor blade of claim 2, where the second airfoil cross-section is a SC2-0714 airfoil profile.

8. The rotor blade of claim 2, where the first airfoil cross-section and the second airfoil cross-section are each a SC2-0714 airfoil profile.

9. The rotor blade of claim 2, where the third airfoil cross-section is a 30.1% thick FFA airfoil profile.

10. The rotor blade of claim 2, where the upper surface of the first blade joins smoothly with the upper surface of the outboard blade section and the lower surface of the second blade joins smoothly with the lower surface of the outboard blade section.

11. The rotor blade of claim 2, where the first chord, the second chord, and the third chord are each equal at the mid-blade end of the respective inboard blade section and outboard blade section.

12. The rotor blade of claim 2, where the length of the inboard blade section is one-quarter the length of the outboard blade section.

13. A wind turbine blade array comprising a hub and a plurality of turbine blades radiating from the hub, each turbine blade in the plurality of turbine blades comprising:
(a) an inboard blade section having a length, an inboard end, and a mid-blade end opposite the inboard end, the inboard end of the inboard blade section being joined to the blade root, the inboard blade section comprising a biplane wing, the biplane wing having a first blade and a second blade, the first blade having a first airfoil cross-section, a first leading edge, a first trailing edge, a first chord, and an upper surface, the second blade having a second airfoil cross-section, a second leading edge, a second trailing edge, a second chord, and a lower surface, the second blade being downwind from the first blade with respect to a wind direction; and
(b) an outboard blade section having a length, a mid-blade end, an outboard end opposite the mid-blade end, an upper surface, and a lower surface, the outboard blade section comprising a monoplane wing having a third airfoil cross-section, a third leading edge, a third trailing edge, and a third chord, the mid-blade end of the outboard blade section being joined to the mid-blade end of the inboard blade section.

14. The rotor blade of claim 13, the first blade being staggered with respect to the second blade.

15. The rotor blade of claim 13, where the first airfoil cross-section and the second airfoil cross-section are each a SC2-0714 airfoil profile.

16. The rotor blade of claim 13, where the third airfoil cross-section is a 30.1% thick FFA airfoil profile.

17. The rotor blade of claim 13, where the upper surface of the first blade blends smoothly with the upper surface of the outboard blade section and the lower surface of the second blade blends smoothly with the lower surface of the outboard blade section.

18. The rotor blade of claim 13, where the length of the inboard blade section is one-quarter the length of the outboard blade section.

19. The rotor blade of claim 13, where the plurality of turbine blades is three turbine blades radially spaced 120 degrees apart.

20-31. (canceled)
